(19) United States
(12) Patent Application Publication
(10) Pub. No.: US 2007/0179775 A1
(43) Pub. Date: Aug. 2, 2007

(54) Method and system for translating a software application into an alternative language

(76) Inventors: Brian D. Bauman, Austin, TX (US); Amanda J. Burton, Austin, TX (US); Michael P. Carlson, Austin, TX (US); Herman Rodriguez, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/343,189

(22) Filed: Jan. 30, 2006

(51) Int. Cl. G06F 17/20

(52) U.S. Cl. 704/8

(57) ABSTRACT

A method, system, and computer program product for allowing a translator to dynamically change the static text displayed by an application to an alternative language.

### BACKGROUND

1. Technical Field of the Present Invention

The present invention generally relates to application software, and more specifically, to methods, systems, and computer program products that translate the application software into one or more alternative languages.

2. Description of Related Art

The rapid globalization of economies and their dependence upon various aspects of technology has resulted in an exponential growth of the market for software driven applications.

Software companies are increasingly finding themselves in the unique position of either expanding their market, and thus profits, into these growing economies or risk losing the potential market to an existing or new competitor.

Global software applications are typically developed by writing the application in a preferred language (e.g. English or German), debugging and testing, and then translating the final version of the application into the various languages required by the desired markets.

The process of translating an application to a non-native language is time consuming and tedious. The translation itself is not just a matter of simply substituting a native phrase or word for a non-native one, but rather, the translator must take into account the context of the phrase or word.

Often times, the translation text of the application software is automated using scripts or similar methods, a common theme is that the translator is often required to work with the executing application while making notes, screen shots (a static copy of the current view of the display device executing the application), and the like to indicate the required changes or verify that the required changes were made correctly.

For example, a translator will execute the translated software application, take screen shots, and indicate the required changes either in notes or on the screen shots themselves. These changes are provided to a programmer or other individual who has authorization to modify the application. The translator reviews each screen of the updated application and compares the changes with screen shots and/or notes as previously described. The need to work with two separate documents during the translation process increases the risk of introducing errors.

It would, therefore, be a distinct advantage if the translator were able to execute the application and dynamically create or change the displayed text during runtime.

### SUMMARY OF THE PRESENT INVENTION

In one aspect, the present invention is a method, apparatus, and computer program product capable of dynamically changing the static text displayed by a software application during its execution. The method includes the step of selecting a component of the software application that is displaying static text. The method further includes the step of changing the static text of the selected component.

### BRIEF DESCRIPTION OF THE DRAWINGS

The present invention will be better understood and its numerous advantages will become more apparent to those skilled in the art by reference to the following drawings, in conjunction with the accompanying specification, in which:

FIG. 1 is a block diagram illustrating a computer system that implements a preferred embodiment of the present invention;

FIG. 2 is a diagram illustrating an example of a graphical representation of a window generated during the execution of the application software of FIG. 1 according to the teachings of a preferred embodiment of the present invention;

FIG. 3 is a diagram is illustrating the window example of FIG. 2 with the translator selecting the accounts so that the displayed text can be changed while the application is executing according to the teachings of a preferred embodiment of the present invention.

FIG. 4 is a diagram illustrating the creation of a translation window as a result of selecting the accounts as explained in connection with FIG. 3 according to the teachings of a preferred embodiment of the present invention.;

FIGS. 5 is a diagram illustrating the accounts translated into the Spanish language in the translation window of FIG. 4 according to the teachings of a preferred embodiment of the present invention.

FIG. 6 is a diagram illustrating the example window of FIG. 2 with the accounts translated into the Spanish language as specified in the translation window of FIG. 5 according to the teachings of a preferred embodiment of the present invention;

FIG. 7 is a diagram illustrating the window example of FIG. 2 with the translator selecting the save button in order to change the display text according to the teachings of a preferred embodiment of the present invention;

FIG. 8 is a diagram illustrating the creation of a translation window as a result of selecting the save button as explained in connection with FIG. 7 according to the teachings of a preferred embodiment of the present invention.;

FIG. 9 is a diagram illustrating the example window of FIG. 2 with the save button translated into the Spanish language as specified in the translation window of FIG. 8 according to the teachings of a preferred embodiment of the present invention; and

FIG. 10 is a flow chart illustrating the method used by the application of FIG. 1 to allow a translator to specify an alternative language for one or more of its components according to the teachings of the present invention.

### DETAILED DESCRIPTION OF THE PREFERRED EMBODIMENT OF THE PRESENT INVENTION

The present invention is a method, system, and computer program product for dynamically translating the various text components of an application from a native to an alternative language. The translator can select each individual component that displays text and change the text to an alternative language or correct the display of the existing text while the application is executing.

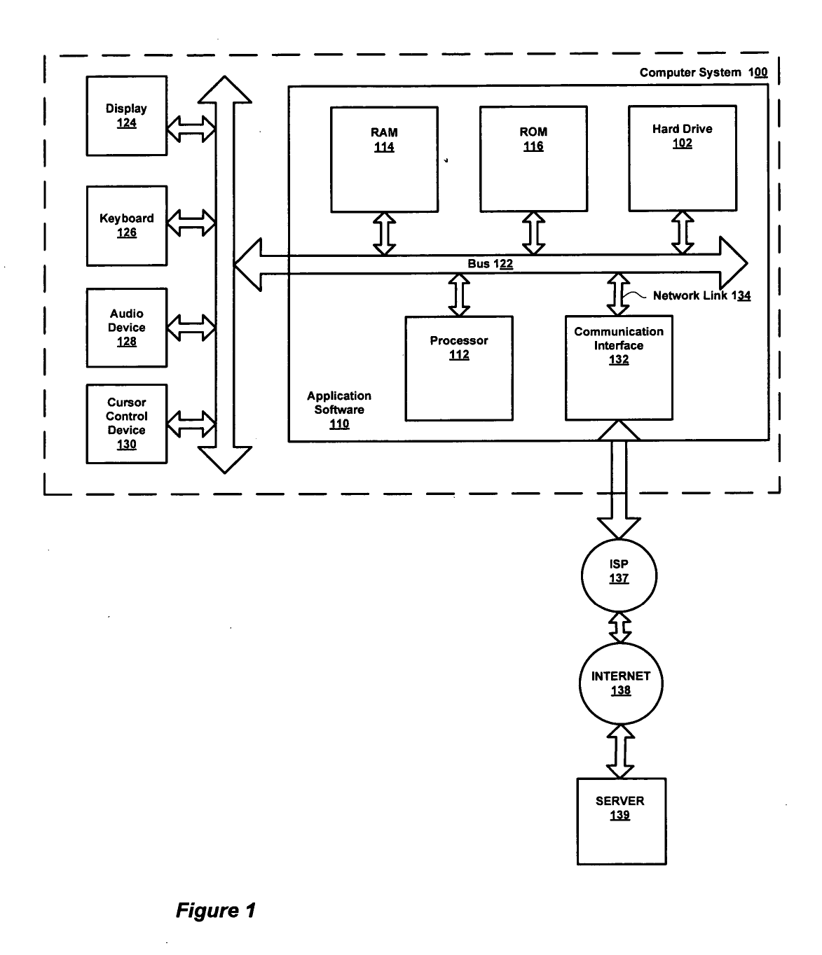

Reference now being made to FIG. 1, a block diagram is shown illustrating a computer system 100 that implements a preferred embodiment of the present invention. Computer System 100 includes various components each of which are explained in greater detail below.

Bus 122 represents any type of device capable of providing communication of information within Computer System 100 (e.g., System bus, PCI bus, cross-bar switch, etc.)

Processor 112 can be a general-purpose processor (e.g., the PowerPC™ manufactured by IBM or the Pentium™ manufactured by Intel) that, during normal operation, processes data under the control of an operating system and application software 110 stored in a dynamic storage device such as Random Access Memory (RAM) 114 and a static storage device such as Read Only Memory (ROM) 116. The operating system preferably provides a graphical user interface (GUI) to the user.

The present invention, including the alternative preferred embodiments, can be provided as a computer program product, included on a machine-readable medium having stored on it machine executable instructions used to program computer system 100 to perform a process according to the teachings of the present invention.

The term “machine-readable medium” as used in the specification includes any medium that participates in providing instructions to processor 112 or other components of computer system 100 for execution. Such a medium can take many forms including, but not limited to, non-volatile media, and transmission media. Common forms of non-volatile media include, for example, a floppy disk, a flexible disk, a hard disk, magnetic tape, or any other magnetic medium, a Compact Disk ROM (CD-ROM), a Digital Video Disk-ROM (DVD-ROM) or any other optical medium whether static or rewriteable (e.g., CDRW and DVD RW), punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the preferred embodiment, an example of a non-volatile medium is the Hard Drive 102.

Volatile media includes dynamic memory such as RAM 114. Transmission media includes coaxial cables, copper wire or fiber optics, including the wires that comprise the bus 122. Transmission media can also take the form of acoustic or light waves, such as those generated during radio wave or infrared data communications.

Moreover, the present invention can be downloaded as a computer program product where the program instructions can be transferred from a remote computer such as server 139 to requesting computer system 100 by way of data signals embodied in a carrier wave or other propagation medium via network link 134 (e.g., a modem or network connection) to a communications interface 132 coupled to bus 122.

Communications interface 132 provides a two-way data communications coupling to network link 134 that can be connected, for example, to a Local Area Network (LAN), Wide Area Network (WAN), or as shown, directly to an Internet Service Provider (ISP) 137. In particular, network link 134 may provide wired and/or wireless network communications to one or more networks.

ISP 137 in turn provides data communication services through the Internet 138 or other network. Internet 138 may refer to the worldwide collection of networks and gateways that use a particular protocol, such as Transmission Control Protocol (TCP) and Internet Protocol (IP), to communicate with one another. ISP 137 and Internet 138 both use electrical, electromagnetic, or optical signals that carry digital or analog data streams. The signals through the various networks and the signals on network link 134 and through communication interface 132, which carry the digital or analog data to and from computer system 100, are exemplary forms of carrier waves transporting the information.

In addition, multiple peripheral components can be added to computer system 100. For example, audio device 128 is attached to bus 122 for controlling audio output. A display 124 is also attached to bus 122 for providing visual, tactile or other graphical representation formats. Display 124 can include both non-transparent surfaces, such as monitors, and transparent surfaces, such as headset sunglasses or vehicle windshield displays.

A keyboard 126 and cursor control device 130, such as mouse, trackball, or cursor direction keys, are coupled to bus 122 as interfaces for user inputs to computer system 100.

The execution of application software 110 on computer system 100 according to a preferred embodiment of the present invention is explained in greater detail below.

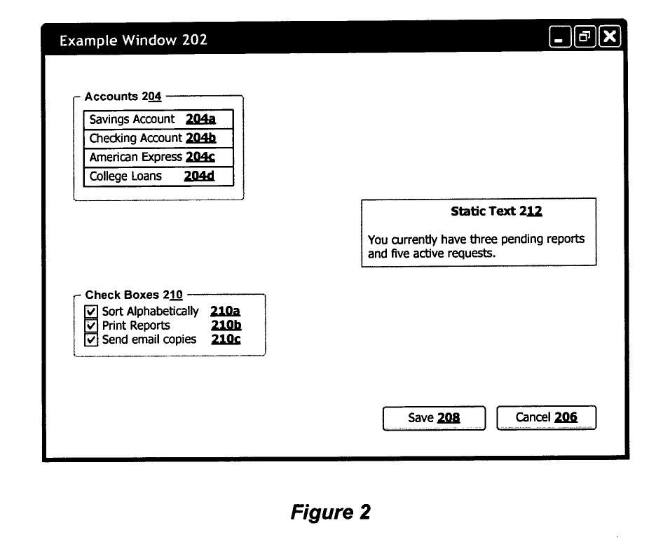

Reference now being made to FIG. 2, a diagram is shown illustrating an example of a graphical representation of a window 202 generated during the execution of the application software 110 of FIG. 1 according to the teachings of a preferred embodiment of the present invention. Application software 110 can be any type of software that generates a graphical representation for providing information to a user in a human readable format (e.g. business, technical, accounting and the like).

In the present example, window 202 is representative of a window type environment such as Windows 2000™ or Windows XP™. This environment, however, is not intended to be a limitation on the types of graphical representations to which the present invention is applicable, but rather, as a convenient and familiar interface from which to provide an explanation of the present invention.

The type and number of components that can be displayed by window 202 are numerous. For ease of explanation, window 202 has been illustrated as having the following components: a group list (Accounts 204), a group of check boxes (Check Boxes 210), static text 212, save button 208, and cancel button 206.

The group list Accounts 204, in this example, displays a group of bank accounts such as Savings Account 204a, Checking Account 204b, American Express™ 204c, and College Loans 204d.

The check Boxes 210 includes options for sorting the Accounts 204 alphabetically (Sort Alphabetically 210a), printing reports (Print Reports 210b), and sending email copies of the reports (Send email copies 210c).

The static text 212 is used for displaying information such as pending reports and active requests.

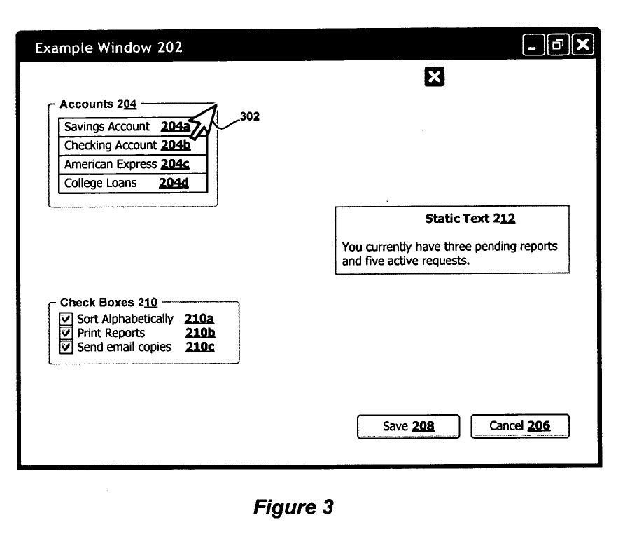

In the present example, the native language is English and it can be assumed that there is a translator executing application 110 who desires to translate the application 110 into the Spanish language. Alternatively, the application 110 could have already been translated into a target language (e.g. Spanish) using a script or other tool and the translator is now review and fixing any incorrectly displayed Spanish text. In the preferred embodiment of the present invention, the translator uses the mouse (cursor control device 130) and an arrow (Cursor) to select a component as explained in connection with FIG. 3 below. The particular device or method used to select a component is not intended to be a limitation of the present invention, and in fact, the selection of the component can easily be accomplished using any of the keys on the keyboard (e.g. function, tab, control, etc.) or any other input device.

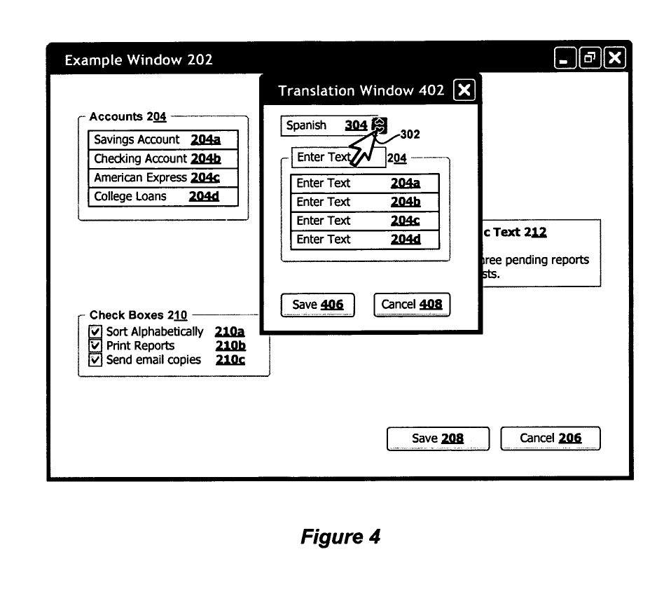

Reference now being made to FIG. 3, a diagram is shown illustrating the window 202 example of FIG. 2 with the translator selecting the accounts 204 so that the displayed text can be changed while the application 110 is executing according to the teachings of a preferred embodiment of the present invention. To change the text of the accounts 204, the user manipulates an arrow 302 (or other visual representation) so that it is positioned over the accounts 204 and proceeds to tap the left button on the mouse 130 (in this particular example the accounts 204 is a group having a static list). The tapping of the mouse results in the creation of new translation window 402 (e.g. dialog) as explained in connection with FIG. 4 below.

In order to ensure that only an authorized translator (versus a typical end-user) has this ability, the design of the application can use any of the well known techniques for limiting access to authorized individuals such as password, authorization levels, command line options and the like.

Reference now being made to FIG. 4, a diagram is shown illustrating the creation of a translation window 402 as a result of selecting the accounts 204 as explained in connection with FIG. 3 according to the teachings of a preferred embodiment of the present invention. In continuation of the example of FIG. 3, the tapping of the mouse results in the creation of a translation window 402. The particular components that are illustrated as being used in the translation window 402 for the selection of the alternative language, the display of the current selected language for the selected component (i.e. accounts 204), and the entering of the translation are designer selective choices, and therefore, it should be understood that the present invention is not limited to any particular interface for accomplishing these tasks.

Located within translation window 402 is a language spin button selection 304 for selecting the particular language that the translator would like to enter in for the selected component (in this example, the accounts 204). In this particular example, the translator has selected the Spanish language via the cursor 302 (Alternatively, the translator may leave the language selection on the current language being supported by the application). Upon the selection of the language, the accounts 204 are displayed using the text entered and saved for the selected language. If, as in this example, no text has been entered for the selected language then the translator is prompted to enter in the alternative language for the accounts 204 component with the prompt text of “enter text”.

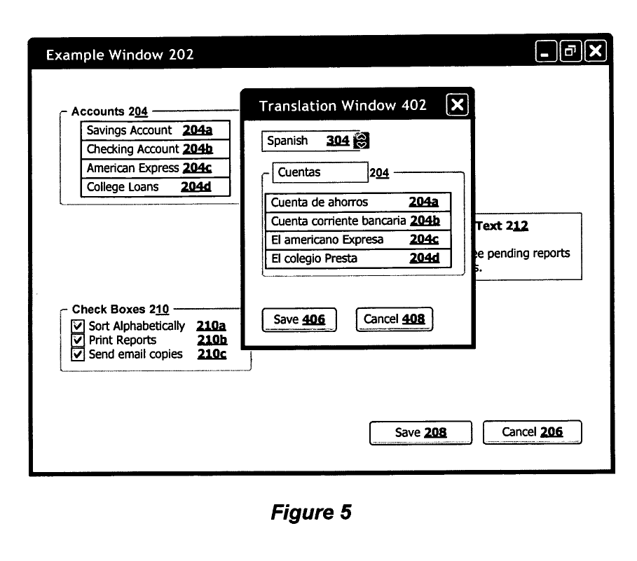

For the moment, it can be assumed that the translator has entered in the Spanish language representations for the accounts 204 component in the translation window 402 as illustrated in FIG. 5.

The translator has the option to either discard the changes they have made or save them using either the cancel 406 or save 408 buttons, respectively. Assuming that the translator desires to save the changes shown in FIG. 5, the translator selects the save button 408 and the alternative text is saved according to the design of the application and particular data structures of the underlying programming language. In example, the designer could cause all text related structures to be compiled using conditional statements that would be selected based upon the selected language, or each object displaying text would read that text from a file.

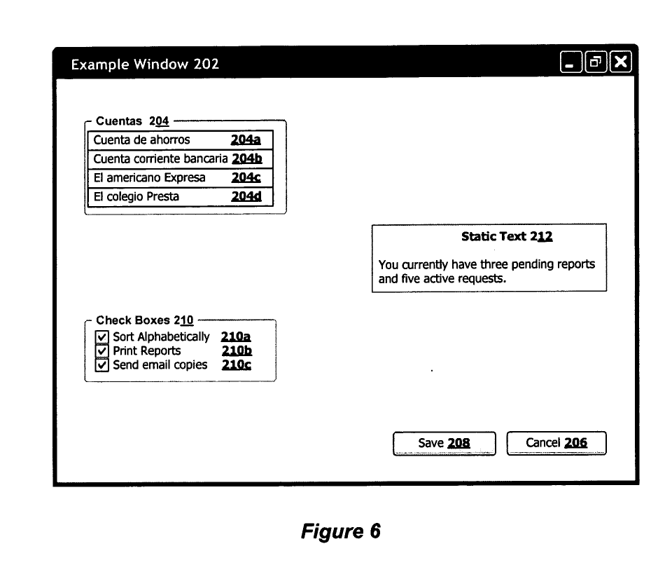

The accounts 204 is now displayed in the Spanish language as previously entered in the translation window 402 as now illustrated by FIG. 6.

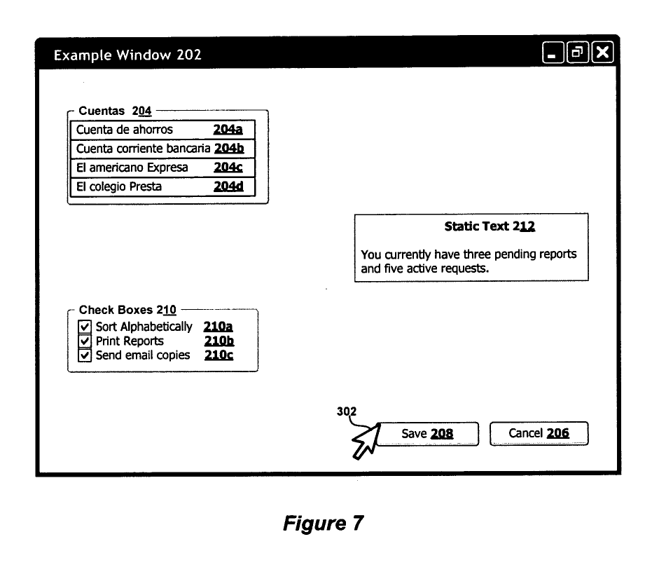

The translator can select any text displayed with window 200 (e.g. text displayed by a button) for alteration as illustrated and explained in connection with FIG. 7 below.

Reference now being made to FIG. 7, a diagram is shown illustrating the window 202 example of FIG. 2 with the translator selecting the save button 208 in order to change the display text of a selected component according to the teachings of a preferred embodiment of the present invention. More specifically, the translator now desires to change the text of the save button 208 to the Spanish language.

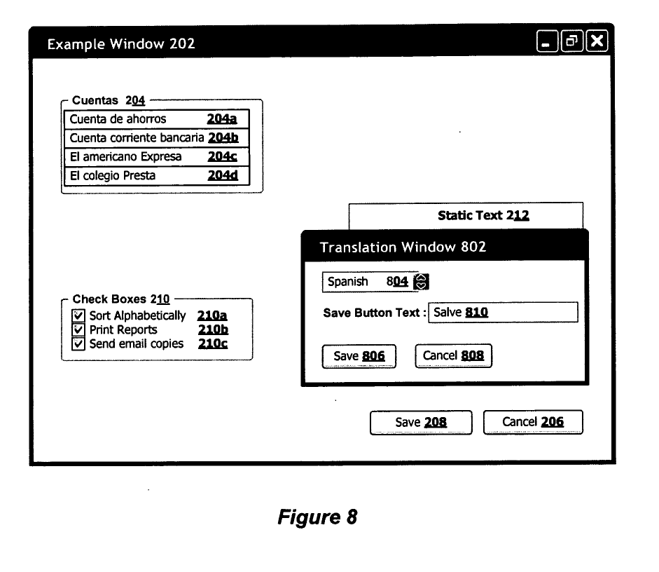

The translator uses the arrow 302, and right clicks the mouse 130 to create the translator window (e.g. dialog) 702 as illustrated in FIG. 8. Again, the translator can select any languages indicated by the language spin button 804. In this example, the translator continues to use the cursor 302 to select the Spanish language, and enters the Spanish representation for the text of the save button 208 in the text box 808.

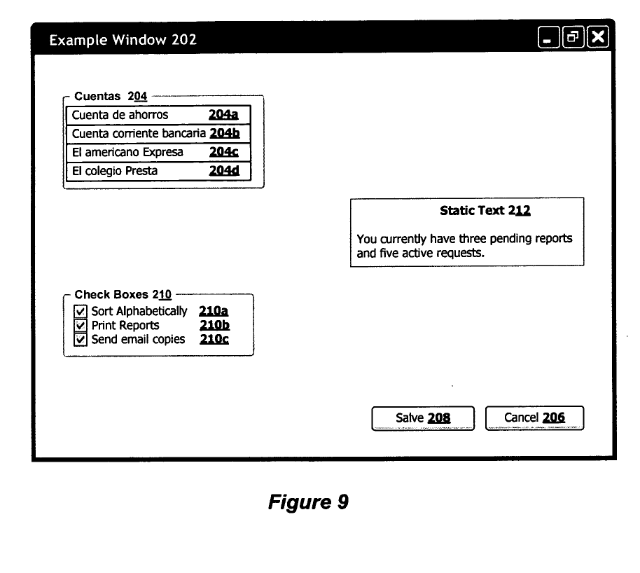

Assuming again that the translator saves their work using the save button 806, the text of save button 208 as illustrated in FIG. 9.

It should be noted, that although the description provided with the previous Figures was in connection with the translator changing the text of the executing application from its current language (e.g. English) to a target language (e.g. Spanish), the translator could also modify the display of the current language (e.g. leaving the language spin button 804 on the current language)

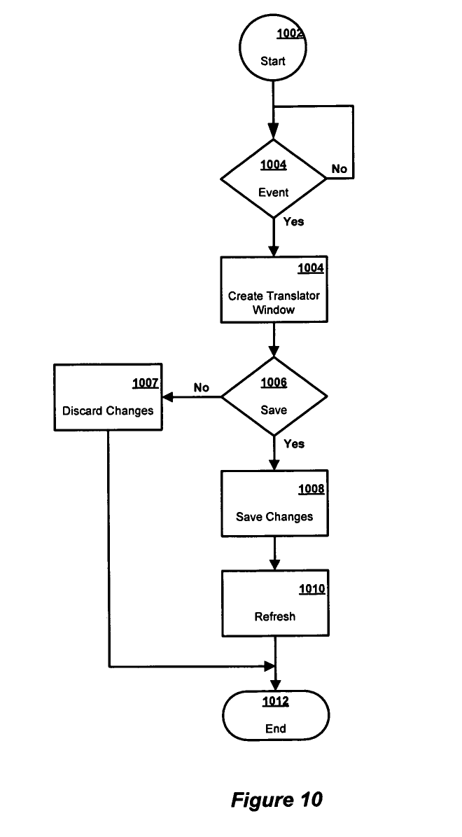

Reference now being made to FIG. 10, a flow chart is shown illustrating the method used by the application 110 of FIG. 1 to allow a translator to specify an alternative language for one or more of its components according to the teachings of the present invention.

The method begins with the execution of application 110 (Step 1002). The method waits for the occurrence of an event indicating the desire of the translator to specify an alternative language for one of the components of window 202 (right mouse click, hot key, etc. . .) (Step 1004). Upon the occurrence of the event, a translator window is created that allows the translator to select the alternative language, provide the text for the selected component, and either save or discard the changes as previously explained. The editor used for providing the text of the alternative language would support any special characters or requirements of the alternative language.

If the translator discards the changes (Steps 1006 and 1007) the method proceeds to end (Step 1012). If, however, the translator saves the changes (Steps 1006 and 1008), then the method proceeds to save the selected language and the associated text for the selected component (Step 1008) according to the design of the application and particular data structures of the underlying programming language. In example, the designer could cause all text related structures to be compiled using conditional statements that would be selected based upon the selected language, or each object displaying text would read that text from a file. The saving of the text can be, for example, saved in a file that is associated with the selected component. The translation window is closed and the underlying components of window 202 are instructed to redraw (Step 1010). The method then proceeds to end (Step 1012).

It is thus believed that the operation and construction of the present invention will be apparent from the foregoing description. While the method, system, and computer program product shown and described has been characterized as being preferred, it will be readily apparent that various changes and/or modifications could be made without departing from the spirit and scope of the present invention as defined in the following claims.

What is claimed is:

1. A method of dynamically changing static text displayed by a software application during its execution, the method comprising:
selecting a component of the software application that is displaying static text; and
changing the static text of the selected component.

2. The method of claim 1 wherein the step of changing includes the steps of:
accepting data entered by the user for static text of the selected component in the correct format for a specified language; and
storing the entered data, an indication of the selected component, and the specified language.

3. The method of claim 2 wherein the step of changing includes the step of:
accepting the selection of one or more languages that are different from the current language being used to display the text of the selected component.

4. The method of claim 3 wherein the step of changing includes the step of:
displaying the static text of the selected component in the selected language.

5. The method of claim 1 wherein the step of selecting includes the step of:
selecting the component using a pointing device.

6. The method of claim 5 wherein the step of changing includes the step of:
indicating with the pointing device that the user desires to change the static text of the selected component.

7. The method of claim 6 wherein the step of changing includes:
creating a window having an input field for allowing the user to type in the static text of the selected component in the correct format.

8. An apparatus for dynamically changing the static text displayed by a software application during its execution, the apparatus comprising:
means for selecting a component of the software application that is displaying static text; and
means for changing the static text of the selected component.

9. The apparatus of claim 8 wherein the means for changing includes:
means for accepting data entered by the user for static text of the selected component in the correct format for a specified language; and
means for storing the entered data, an indication of the selected component, and the specified language.

10. The apparatus of claim 9 wherein the means for changing includes:
accepting the selection of one or more languages that are different from the current language being used to display the text of the selected component.

11. The apparatus of claim 10 wherein the means for changing includes:
means for displaying the static,text of the selected component in the selected language.

12. The apparatus of claim 9 wherein the means for selecting includes:
means for selecting the component using a pointing device.

13. The apparatus of claim 12 wherein the means for changing includes:
means for indicating with the pointing device that the user desires to change the static text of the selected component.

14. The apparatus of claim 13 wherein the means for changing includes:
means for creating a window having an input field for allowing the user to type in the static text of the selected component in the correct format.

15. A computer program product comprising a computer usable medium having computer usable program code for dynamically changing the static text displayed by a software application during its execution, the computer program product including:
computer usable program code for selecting a component of the software application that is displaying static text; and
computer usable program code for changing the static text of the selected component.

16. The computer program product of claim 15 wherein the computer usable program code for changing includes:
computer usable program code for accepting data entered by the user for static text of the selected component in the correct format for a specified language; and
computer usable program code for storing the entered data, an indication of the selected component, and the specified language.

17. The computer program product of claim 16 wherein the computer usable program code for changing includes:
computer usable program code for accepting the selection of one or more languages that are different from the current language being used to display the text of the selected component.

18. The computer program product of claim 17 wherein the computer usable program code for changing includes:
computer usable program code for displaying the static text of the selected component in the selected language.

19. The computer program product of claim 15 wherein the computer usable program code for selecting includes:
computer usable program code for selecting the component using a pointing device.

20. The computer program product of claim 19 wherein the computer usable program code for changing includes:
computer usable program code for creating a window having an input field for allowing the user to type in the static text of the selected component in the correct format.
